(19) United States
(12) Patent Application Publication
(10) Pub. No.: US 2026/0067478 A1
(43) Pub. Date: Mar. 5, 2026

(54) METHOD FOR VIDEO TRANSCODING, APPARATUS, ELECTRONIC DEVICE, AND READABLE STORAGE MEDIUM

(71) Applicant: BEIJING BAIDU NETCOM SCIENCE TECHNOLOGY CO., LTD., Beijing (CN)

(72) Inventor: Xue LI, Beijing (CN)

(73) Assignee: BEIJING BAIDU NETCOM SCIENCE TECHNOLOGY CO., LTD., Beijing (CN)

(21) Appl. No.: 19/345,102

(22) Filed: Sep. 30, 2025

(30) Foreign Application Priority Data
Nov. 13, 2024 (CN) 202411621571.7

(51) Int. Cl. H04N 19/40; H04N 19/105; H04N 19/159; H04N 19/176; H04N 19/196; H04N 19/513

(52) U.S. Cl. CPC H04N 19/40; H04N 19/105; H04N 19/159; H04N 19/176; H04N 19/198; H04N 19/521

(57) ABSTRACT

A method for video transcoding, an apparatus, an electronic device and a readable storage medium are suggested, which relates to the technical field of artificial intelligence including video processing, big data, and cloud services. The method for video transcoding includes: decoding an initial compressed video file to obtain an original compressed video file and a decoding dataset acquired during a decoding process; obtaining a target decoding sub-data from a decoding data corresponding to a frame to be encoded according to a position of a first coding unit in the frame to be encoded; performing a predictive coding on the first coding unit according to the target decoding sub-data to obtain a first prediction block of the frame to be encoded; obtaining a target compressed video file according to each frame to be encoded and the corresponding first prediction block.

### CROSS-REFERENCE TO RELATED APPLICATIONS

The present application claims the priority of Chinese Patent Application No. 202411621571.7, filed on Nov. 13, 2024, with the title of “METHOD FOR VIDEO TRANSCODING, APPARATUS, ELECTRONIC DEVICE, AND READABLE STORAGE MEDIUM”. The disclosure of the above application is incorporated herein by reference in its entirety.

### FIELD OF THE DISCLOSURE

The present disclosure relates to the field technical of Internet technology, particularly in the technical field of artificial intelligence including video processing, big data, and cloud services. The present disclosure provides a method for video transcoding, an apparatus, an electronic device, and a readable storage medium.

### BACKGROUND OF THE DISCLOSURE

In existing technologies, when performing video transcoding, a commonly adopted approach is that, after decoding an initial compressed video file, the original compressed video file obtained from a decoding is encoded using a certain fixed configuration of encoding parameters. That is, the original compressed video file is encoded without the prior knowledge to complete the video transcoding. The video transcoding methods of the existing technology have problems such as high hardware resource consumption and slow transcoding speed.

### SUMMARY OF THE DISCLOSURE

According to a first aspect of the present disclosure, there is provided a method for video transcoding, including: decoding an initial compressed video file to obtain an original compressed video file and a decoding dataset acquired during a decoding process, wherein each decoding data in the decoding dataset respectively corresponds to a frame to be encoded in the original compressed video file; obtaining a target decoding sub-data from the decoding data corresponding to the frame to be encoded according to a position of a first coding unit in the frame to be encoded; performing a predictive coding on the first coding unit according to the target decoding sub-data to obtain a first prediction block of the frame to be encoded; obtaining a target compressed video file according to each frame to be encoded and the corresponding first prediction block.

According to a second aspect of the present disclosure, there is provided an electronic device, including: at least one processor; and a memory communicatively connected with the at least one processor; wherein the memory stores instructions executable by the at least one processor, and the instructions are executed by the at least one processor to enable the at least one processor to perform a method for video transcoding, wherein the method for video transcoding includes: decoding an initial compressed video file to obtain an original compressed video file and a decoding dataset acquired during a decoding process, wherein each decoding data in the decoding dataset respectively corresponds to a frame to be encoded in the original compressed video file; obtaining a target decoding sub-data from decoding data corresponding to the frame to be encoded according to a position of a first coding unit in the frame to be encoded; performing predictive coding on the first coding unit according to the target decoding sub-data to obtain a first prediction block of the frame to be encoded; obtaining a target compressed video file according to each frame to be encoded and the corresponding first prediction block.

According to a third aspect of the present disclosure, there is provided a non-transitory computer readable storage medium with computer instructions stored thereon, wherein the computer instructions are used for causing a method for video transcoding, wherein the method for video transcoding includes: decoding an initial compressed video file to obtain an original compressed video file and a decoding dataset acquired during a decoding process, wherein each decoding data in the decoding dataset respectively corresponds to a frame to be encoded in the original compressed video file; obtaining a target decoding sub-data from decoding data corresponding to the frame to be encoded according to a position of a first coding unit in the frame to be encoded; performing predictive coding on the first coding unit according to the target decoding sub-data to obtain a first prediction block of the frame to be encoded; obtaining a target compressed video file according to each frame to be encoded and the corresponding first prediction block.

It should be understood that the content described in this section is not intended to identify key or important features of the present embodiments of the present disclosure, nor is it used to limit the scope of the present disclosure. Other features of the present disclosure will become readily understandable through the following specification.

### BRIEF DESCRIPTION OF DRAWINGS

The drawings are used to better understand the present scheme and do not constitute a limitation on the present disclosure. In the drawings:

FIG. 1 is a schematic diagram according to a first embodiment of the present disclosure;

FIG. 2 is a schematic diagram according to a second embodiment of the present disclosure;

FIG. 3 is a schematic diagram according to a third embodiment of the present disclosure;

FIG. 4 is a schematic diagram according to a fourth embodiment of the present disclosure;

FIG. 5 is a schematic diagram according to a fifth embodiment of the present disclosure;

FIG. 6 is a block diagram of an electronic device for implementing the method for video transcoding according to embodiments of the present disclosure.

### DETAILED DESCRIPTION OF PREFERRED EMBODIMENTS

The following makes explanations of exemplary embodiments of the present disclosure in conjunction with the drawings, which include various details of the present embodiments of the present disclosure to aid in an understanding, and the exemplary embodiments should be considered as merely exemplary. Therefore, those skilled in the art should recognize that various changes and modifications can be made to the present embodiments described herein without departing from the scope and spirit of the present disclosure. Similarly, for clarity and conciseness, descriptions of known functions and structures are omitted in the following description.

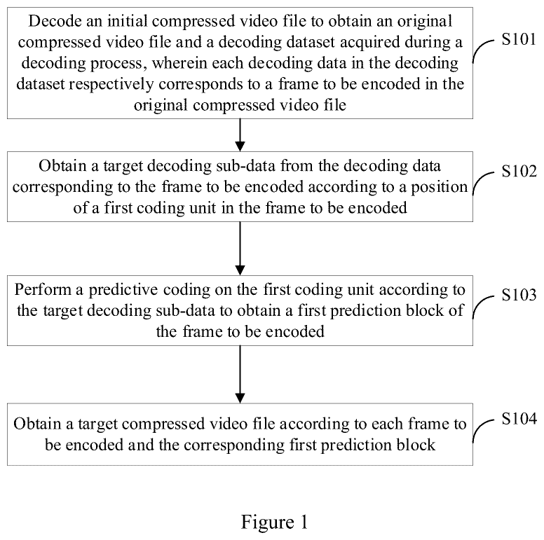

FIG. 1 is a schematic diagram according to a first embodiment of the present disclosure. As shown in FIG. 1, the method for video transcoding of the present embodiment specifically includes the following steps of:
S101, Decoding an initial compressed video file to obtain an original compressed video file and a decoding dataset acquired during a decoding process, wherein each decoding data in the decoding dataset respectively corresponds to a frame to be encoded in the original compressed video file;
S102, Obtaining a target decoding sub-data from the decoding data corresponding to the frame to be encoded according to a position of a first coding unit in the frame to be encoded;
S103, Performing a predictive coding on the first coding unit according to the target decoding sub-data to obtain a first prediction block of the frame to be encoded;
S104, Obtaining a target compressed video file according to each frame to be encoded and the corresponding first prediction block.

The method for video transcoding of the present embodiment, by using the decoding dataset acquired when decoding the initial compressed video file, optimizes a predictive coding process of the first coding unit of the frame to be encoded in the original compressed video file, which can effectively improve a utilization rate of the decoding data. This can avoid problems in the existing technology due to discarding the decoding data (i.e., no prior knowledge) which leads to a need to search for more prediction modes during the predictive coding process, thereby reducing the hardware resource consumption, and improving the video file transcoding speed and the transcoding efficiency.

In the present embodiment, when executing S101, a video decoder module can be called to perform a video decoding on the initial compressed video file. The present embodiment does not impose limitations on the type of the video decoder module.

In the present embodiment, when performing a video decoding operation on the initial compressed video file through the video decoder module, a statistics can be performed on a Video Parameter Set (VPS), a Sequence Parameter Set (SPS), a Picture Parameter Set (PPS), etc., thereby obtaining the decoding data corresponding to each video frame (i.e., the frame to be encoded) in the original compressed video file obtained after decoding the initial compressed video file.

In the present embodiment, the decoding data corresponding to different frames to be encoded includes a decoded video information (for example a decoded header information), a decoded video frame information (for example a frame number, a frame type, a frame resolution, a coding block size, a minimum prediction block, a minimum transform block, a reference frame information (for example a reference frame list, a reference frame absolute position difference, etc.) of a frame to be decoded corresponding to the frame to be encoded), and a decoded video block information (for example a residual coding bit of a second coding unit, a prediction mode (an intra prediction mode or an inter prediction mode) of a second prediction unit, a motion vector of the second prediction unit, the intra prediction mode of the second prediction unit, etc.).

It can be appreciated that, in the present embodiment, the first coding unit, the first prediction unit, etc. are a coding unit or a prediction unit corresponding to the frame to be encoded. The second coding unit, the second prediction unit, etc. are the coding unit or the prediction unit corresponding to the frame to be decoded.

In the present embodiment, the frame to be decoded is a video frame in the initial compressed video file. By decoding the initial compressed video file through the video decoder module, the corresponding frame to be encoded can be obtained according to different frames to be decoded. Then a statistics is performed on the relevant information acquired during the decoding process of the frame to be decoded to obtain the decoding data corresponding to the frame to be encoded.

In the present embodiment, according to the position of the second coding unit or the second prediction unit in the frame to be decoded, the corresponding information is stored in the decoded video block information in a unit of a minimum coding block or the minimum prediction block (a prediction block corresponding to the second coding unit is a second prediction block). For example, it can be storing the residual coding bit corresponding to the minimum coding block of each second coding unit into the decoded video block information, storing the prediction mode corresponding to the minimum prediction block of each second prediction unit into the decoded video block information, storing the motion vector (a forward motion vector, a backward motion vector, a bi-directional motion vector, etc.) corresponding to the minimum prediction block of each second prediction unit into the decoded video block information, and storing the intra prediction mode corresponding to the minimum prediction block of each second prediction unit into the decoded video block information.

For example, in the present embodiment, when executing S101, it can store the decoding dataset in a form of DecodeFrameBuf[i], where i represents the frame to be encoded with a display order of i.

In the present embodiment, after obtaining the original compressed video file and the decoding dataset acquired during the decoding process in S101, it executes S102 to obtain the target decoding sub-data from the decoding data corresponding to the frame to be encoded according to the position of the first coding unit in the frame to be encoded.

After completing the decoding of the initial compressed video file, an encoding process of the obtained original compressed video file can be performed. In the present embodiment, a video encoder module can be called, and the obtained original compressed video file and the decoding dataset are transmitted to the video encoder module, to complete a video transcoding, thereby obtaining the target compressed video file.

In the present embodiment, the frame to be encoded can be first divided into multiple first coding units (Coding Unit, CU). Then the predictive coding can be performed on the divided multiple first coding units, and the first coding unit is an original pixel block in the frame to be encoded.

Since a resolution of a video can change before and after the video transcoding, in the present embodiment, when executing S102 to obtain the target decoding sub-data from the decoding data corresponding to the frame to be encoded according to the position of the coding unit in the frame to be encoded, it can adopt an implementation of: determining a target position of the first coding unit in the frame to be decoded according to a target video resolution, an image padding pixel, an initial video resolution, and the position of the first coding unit in the frame to be encoded; obtaining a partial decoding data (for example, a corresponding video block information) corresponding to the determined target position from the decoding data corresponding to the frame to be encoded, as the target decoding sub-data.

That is, in the present embodiment, when the resolution is different before and after the video transcoding, it can obtain the target decoding sub-data corresponding to the first coding unit from the decoding data corresponding to a current frame to be encoded based on the information such as the resolutions before and after the transcoding. This can improve the accuracy of the obtained target decoding sub-data, which in turn improves the accuracy when performing a predictive decoding on the first coding unit based on the target decoding sub-data.

It can be appreciated that, if the resolution does not change before and after the video transcoding, in the present embodiment, when executing S102, it can directly use the position of the first coding unit in the frame to be encoded as the target position of the first coding unit in the frame to be decoded.

In the present embodiment, after executing S102 to obtain the target decoding sub-data from the decoding data corresponding to the frame to be encoded, it executes S103 to perform the predictive coding on the first coding unit according to the target decoding sub-data to obtain the first prediction block of the frame to be encoded.

In the present embodiment, when executing S103 to perform the predictive coding on the first coding unit according to the target decoding sub-data to obtain the first prediction block of the frame to be encoded, it can adopt an implementation of: determining the frame type of the frame to be encoded according to the target decoding sub-data; performing the predictive coding on the first coding unit using a prediction coding method corresponding to the determined frame type according to the target decoding sub-data to obtain the first prediction block of the frame to be encoded.

In the present embodiment, the frame type of the frame to be encoded is the same as the frame type of the corresponding frame to be decoded. That is, when the frame type of the frame to be decoded is an I frame, then the frame type of the frame to be encoded corresponding to the frame to be decoded is also the I frame, and when the frame type of the frame to be decoded is a P frame or a B frame, then the frame type of the frame to be encoded corresponding to the frame to be decoded is also the P frame or the B frame.

That is, in the present embodiment, the prediction coding method corresponding to different frame types is pre-set, so as to perform the predictive coding on the first coding unit in the frames to be encoded of different frame types according to the corresponding prediction coding method, which can further improve the accuracy of the first prediction block obtained through the predictive coding.

In the present embodiment, after obtaining the first prediction block of the frame to be encoded in S103, it executes S104 to obtain the target compressed video file according to each frame to be encoded and the corresponding first prediction block.

In the present embodiment, a video encoding process can include a prediction, a transform, a quantization, an entropy coding, an inverse quantization, an inverse transform, and a loop filtering.

For the prediction process, the first coding unit is taken as the original pixel block, and an intra prediction or an inter prediction is performed on the first coding unit to obtain the first prediction block. That is, in the step S103 of the present embodiment; the original pixel block and the first prediction block are subtracted to obtain a residual pixel block.

For the transform process, an input is the residual pixel block, and an output is a transform coefficient block obtained by transforming the residual pixel block through a matrix multiplication.

For the quantization process, the transform coefficient block is performed with a signal processing to reduce an amplitude of a signal, in order to obtain a quantized signal.

For the entropy coding process, the entropy coding is performed on the quantized signal to obtain a video encoding bitstream of the video.

For the inverse quantization process, the inverse transform process, and the loop filtering process, the quantized signal is performed with the inverse quantization and the inverse transform, which then is added with a prediction pixel block. The result undergoes the loop filtering to reconstruct a video image.

In the present embodiment, when executing S104, after obtaining the residual pixel block according to the first prediction unit and the first prediction block in the frame to be encoded, it executes a subsequent process of the transform, the quantization, the entropy coding, the inverse quantization, the inverse transform, and the loop filtering, thereby obtaining a final target compressed video file.

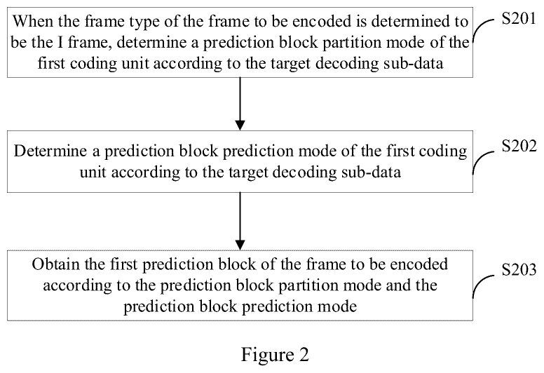

FIG. 2 is a schematic diagram according to a second embodiment of the present disclosure. As shown in FIG. 2, in the present embodiment, when executing the step “performing the predictive coding on the first coding unit using a prediction coding method corresponding to the determined frame type according to the target decoding sub-data to obtain the first prediction block of the frame to be encoded”, it can include the following steps of:
S201, When the frame type of the frame to be encoded is determined to be the I frame, determining a prediction block partition mode of the first coding unit according to the target decoding sub-data;
S202, Determining a prediction block prediction mode of the first coding unit according to the target decoding sub-data;
S203, Obtaining the first prediction block of the frame to be encoded according to the prediction block partition mode and the prediction block prediction mode.

That is, in the present embodiment, when the frame type of the frame to be encoded is determined to be the I frame, it respectively determines the prediction block partition mode and the prediction block prediction mode (the intra prediction mode) of the first coding unit according to the target decoding sub-data corresponding to the frame to be encoded, so as to realize an acceleration of the prediction process in an encoding flow according to a decoding related information obtained during the decoding process. This can improve the speed and the efficiency of obtaining the first prediction block, which thereby correspondingly improves the speed and the efficiency of the video transcoding.

In the present embodiment, when executing S201 to determine the prediction block partition mode of the first coding unit according to the target decoding sub-data, it can adopt an implementation of: obtaining a first decoding residual mean value and a first decoding residual variance corresponding to the first coding unit, and a second decoding residual mean value and a second decoding residual variance corresponding to the frame to be encoded according to the residual coding bit in the target decoding sub-data; determining the prediction block partition mode of the first coding unit according to the first decoding residual mean value, the first decoding residual variance, the second decoding residual mean value and the second decoding residual variance.

In the present embodiment, when executing S201, when it is determined that the prediction mode in the target decoding sub-data only includes a direct current (DC) mode or a planar mode, or only includes the intra angular prediction mode in the prediction mode, and an angle difference between a maximum intra angular prediction mode and a minimum intra angular prediction mode is less than a first threshold, it then skips a quadtree partition and an N×N partition of the first coding unit, and takes a “searching current layer first coding unit” as the prediction block partition mode.

In the present embodiment, when executing S201, when it is determined that the first decoding residual mean value is less than a second threshold, and the first decoding residual variance is less than a third threshold, it then skips the quadtree partition and the N×N partition of the first coding unit, and takes the “searching current layer first coding unit” as the prediction block partition mode.

In the present embodiment, when executing S201, when it is determined that the first decoding residual variance is greater than “the second decoding residual variance×a”, and the first decoding residual variance is greater than a fourth threshold, it then skips the “searching current layer first coding unit”, and takes the quadtree partition or the N×N partition as the prediction block partition mode; In the present embodiment, “a” is a constant.

In the present embodiment, when executing S202 to determine the prediction block prediction mode of the first coding unit according to the target decoding sub-data, it can adopt an implementation of: obtaining an angle mean value and an angle variance of the intra angular prediction mode corresponding to the first coding unit according to the intra angular prediction mode in the target decoding sub-data; determining the prediction block prediction mode of the first coding unit according to the angle mean value and the angle variance.

In the present embodiment, when executing S202, when it is determined that the angle variance is greater than a fifth threshold, it then does not search all of the intra prediction modes, and can only search in several preset intra prediction modes to determine the prediction block prediction mode; When it is determined that the angle variance is less than or equal to the fifth threshold, it can search in the DC mode and the planar mode to determine the prediction block prediction mode, and it can also search in the intra angular prediction modes within an angle range of the angle mean value and surrounding +N angles, or the angle mean value and surrounding −N angles, to determine the prediction block prediction mode.

That is, the present embodiment can be combined with the decoding sub-data corresponding to the first coding unit to accelerate a search process of the prediction block partition mode and the prediction block prediction mode, without a need to perform a search of a full partition mode or a full prediction mode. This can improve the speed and the efficiency when determining the prediction block partition mode and the prediction block prediction mode, which thereby improves the video transcoding speed and the transcoding efficiency.

In the present embodiment, when executing S203, it can then partition the first prediction unit (that is, the prediction unit corresponding to the first coding unit) according to the determined prediction block partition mode, and then obtain the first prediction block according to the determined prediction block prediction mode.

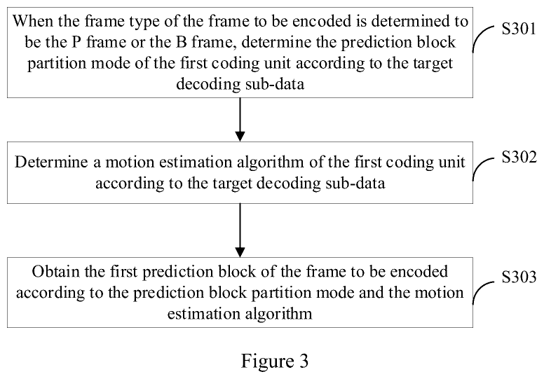

FIG. 3 is a schematic diagram according to a third embodiment of the present disclosure. As shown in FIG. 3, the present embodiment, when executing the step “performing the predictive coding on the first coding unit using a prediction coding method corresponding to the determined frame type according to the target decoding sub-data to obtain the first prediction block of the frame to be encoded”, it can include the following steps of:
S301, When the frame type of the frame to be encoded is determined to be the P frame or the B frame, determining the prediction block partition mode of the first coding unit according to the target decoding sub-data;
S302, Determining a motion estimation algorithm of the first coding unit according to the target decoding sub-data;
S303, Obtaining the first prediction block of the frame to be encoded according to the prediction block partition mode and the motion estimation algorithm.

That is, in the present embodiment, when the frame type of the frame to be encoded is determined to be the P frame or the B frame, it respectively determines the prediction block partition mode and the motion estimation algorithm of the first coding unit according to the target decoding sub-data corresponding to the frame to be encoded, so as to realize an acceleration of the prediction process (the inter prediction) in the encoding flow according to the decoding related information obtained during the decoding process. This can improve the speed and the efficiency of obtaining the first prediction block, which thereby correspondingly improves the video transcoding speed and the efficiency.

In the present embodiment, when executing S301 to determine the prediction block partition mode of the first coding unit according to the target decoding sub-data, it can adopt an implementation of: obtaining a first motion vector variance corresponding to the first coding unit, and a second motion vector variance corresponding to the frame to be encoded according to the motion vector in the target decoding sub-data; obtaining the first decoding residual variance corresponding to the first coding unit, and the second decoding residual variance corresponding to the frame to be encoded according to the residual coding bit in the target decoding sub-data; determining the prediction block partition mode of the first coding unit according to the first motion vector variance, the second motion vector variance, the first decoding residual variance and the second decoding residual variance.

In the present embodiment, when executing S301, when it is determined that the first motion vector variance is greater than “the second motion vector variance×b”, and the first decoding residual variance is greater than “the second decoding residual variance×c”, it then skips the “searching current layer first coding unit”, and takes the quadtree partition as the prediction block partition mode; In the present embodiment, “b” and “c” are constants.

In the present embodiment, when executing S302 to determine the motion estimation algorithm of the first coding unit according to the target decoding sub-data, it can adopt an implementation of: obtaining the first motion vector variance corresponding to the first coding unit according to the target decoding sub-data; determining the motion estimation algorithm of the first coding unit according to the first motion vector variance.

In the present embodiment, when executing S302, when it is determined that the first motion vector variance is less than a sixth threshold, it can take a result of scaling the motion vector in the target decoding sub-data according to the resolution as the motion vector of the first coding unit, and skip a motion search process.

In the present embodiment, when executing S302, when it is determined that the first motion vector variance is greater than or equal to the sixth threshold, it then performs the motion search process.

In the present embodiment, the motion search process can be: first taking a motion estimation vector of the first prediction unit as a motion vector starting search point, then setting a search range of a motion estimation according to a maximum motion vector in the target decoding sub-data and the resolutions before and after the transcoding, and finally performing the motion search process to obtain the motion vector of the first coding unit.

In the present embodiment, when executing S303, it can first partition the first prediction unit (that is, the prediction unit corresponding to the first coding unit) according to the determined prediction block partition mode, and then determine the motion vector and a reference frame of the first coding unit according to the determined motion estimation algorithm, and finally obtain the first prediction block according to the determined motion vector and the reference frame.

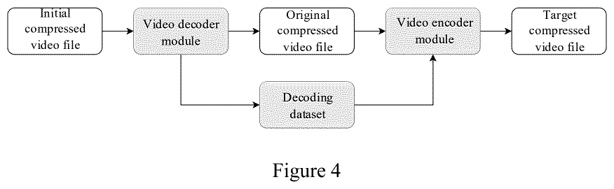

FIG. 4 is a schematic diagram according to a fourth embodiment of the present disclosure. FIG. 4 shows a flowchart of the video transcoding of the present embodiment. First, the video decoder module is used to decode the initial compressed video file to obtain the original compressed video file and the decoding dataset acquired during the decoding process; and then the original compressed video file and the decoding dataset are transmitted to the video encoder module, and the original compressed video file is encoded by the video encoder module according to the decoding dataset, so as to complete the video transcoding and obtain the target compressed video file.

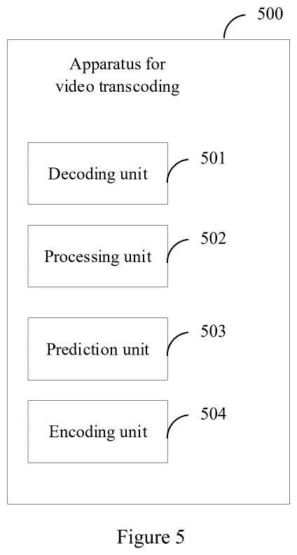

FIG. 5 is a schematic diagram according to a fifth embodiment of the present disclosure. As shown in FIG. 5, the apparatus 500 for video transcoding of the present embodiment includes:
a decoding unit 501, configured to decode an initial compressed video file to obtain an original compressed video file and a decoding dataset acquired during a decoding process, wherein each decoding data in the decoding dataset respectively corresponds to a frame to be encoded in the original compressed video file;
a processing unit 502, configured to obtain a target decoding sub-data from the decoding data corresponding to the frame to be encoded according to a position of a first coding unit in the frame to be encoded;
a prediction unit 503, configured to perform a predictive coding on the first coding unit according to the target decoding sub-data to obtain a first prediction block of the frame to be encoded;
an encoding unit 504, configured to obtain a target compressed video file according to each frame to be encoded and the corresponding first prediction block.

The decoding unit 501 can call a video decoder module to perform a video decoding on the initial compressed video file. The present embodiment does not impose limitations on a type of the video decoder module.

In the present embodiment, the decoding data corresponding to different frames to be encoded includes a decoded video information (for example a decoded header information), a decoded video frame information (for example a frame number, a frame type, a frame resolution, a coding block size, a minimum prediction block, a minimum transform block, a reference frame information (for example a reference frame list, a reference frame absolute position difference, etc.) of a frame to be decoded corresponding to the frame to be encoded), and a decoded video block information (for example a residual coding bit of a second coding unit, a prediction mode (an intra prediction mode or an inter prediction mode) of a second prediction unit, a motion vector of the second prediction unit, the intra prediction mode of the second prediction unit, etc.).

It can be appreciated that, in the present embodiment, the first coding unit, a first prediction unit, etc. are a coding unit or a prediction unit corresponding to the frame to be encoded, and the second coding unit, the second prediction unit, etc. are the coding unit or the prediction unit corresponding to the frame to be decoded.

In the present embodiment, the frame to be decoded is a video frame in the initial compressed video file, and by decoding the initial compressed video file through the video decoder module, the corresponding frame to be encoded can be obtained according to different frames to be decoded, and then a statistics is performed on a relevant information acquired during the decoding process of the frame to be decoded to obtain the decoding data corresponding to the frame to be encoded.

In the present embodiment, a corresponding information is stored in the decoded video block information in a unit of a minimum coding block or a minimum prediction block according to a position of the second coding unit or the second prediction unit in the frame to be decoded; For example, it can be storing the residual coding bit corresponding to the minimum coding block of each second coding unit into the decoded video block information, storing the prediction mode corresponding to the minimum prediction block of each second prediction unit into the decoded video block information, storing the motion vector (a forward motion vector, a backward motion vector, a bi-directional motion vector, etc.) corresponding to the minimum prediction block of each second prediction unit into the decoded video block information, and storing the intra prediction mode corresponding to the minimum prediction block of each second prediction unit into the decoded video block information.

In the present embodiment, after the original compressed video file and the decoding dataset acquired during the decoding process are obtained by the decoding unit 501, the processing unit 502 obtains the target decoding sub-data from the decoding data corresponding to the frame to be encoded according to the position of the first coding unit in the frame to be encoded.

After completing the decoding of the initial compressed video file, an encoding process of the obtained original compressed video file can be performed; In the present embodiment, a video encoder module can be called to transmit the obtained original compressed video file and the decoding dataset to the video encoder module, to complete a video transcoding, thereby obtaining the target compressed video file.

In the present embodiment, the frame to be encoded can be first divided into multiple first coding units (Coding Unit, CU), and then the predictive coding can be performed on the divided multiple first coding units, and the first coding unit is an original pixel block in the frame to be encoded.

Since a resolution of a video can change before and after the video transcoding, the processing unit 502, when obtaining the target decoding sub-data from the decoding data corresponding to the frame to be encoded according to the position of the coding unit in the frame to be encoded, can adopt an implementation of: determining a target position of the first coding unit in the frame to be decoded according to a target video resolution, an image padding pixel, an initial video resolution and the position of the first coding unit in the frame to be encoded; obtaining a partial decoding data (for example a corresponding video block information) corresponding to the determined target position from the decoding data corresponding to the frame to be encoded, as the target decoding sub-data.

That is, when the resolution is different before and after the video transcoding, based on an information such as the resolutions before and after the transcoding, the processing unit 502 can obtain the target decoding sub-data corresponding to the first coding unit from the decoding data corresponding to a current frame to be encoded. This can improve the accuracy of the obtained target decoding sub-data, which in turn improves the accuracy when performing the predictive decoding on the first coding unit based on the target decoding sub-data.

It can be appreciated that, if the resolution does not change before and after the video transcoding, the processing unit 502 can directly use the position of the first coding unit in the frame to be encoded as the target position of the first coding unit in the frame to be decoded.

In the present embodiment, after the target decoding sub-data is obtained from the decoding data corresponding to the frame to be encoded by the processing unit 502, the prediction unit 503 performs the predictive coding on the first coding unit according to the target decoding sub-data to obtain the first prediction block of the frame to be encoded.

When performing the predictive coding on the first coding unit according to the target decoding sub-data to obtain the first prediction block of the frame to be encoded, The prediction unit 503 can adopt an implementation of: determining the frame type of the frame to be encoded according to the target decoding sub-data; performing the predictive coding on the first coding unit using a prediction coding method corresponding to the determined frame type according to the target decoding sub-data to obtain the first prediction block of the frame to be encoded.

In the present embodiment, the frame type of the frame to be encoded is the same as the frame type of the corresponding frame to be decoded. That is, when the frame type of the frame to be decoded is an I frame, then the frame type of the frame to be encoded corresponding to the frame to be decoded is also the I frame, and when the frame type of the frame to be decoded is a P frame or a B frame, then the frame type of the frame to be encoded corresponding to the frame to be decoded is also the P frame or the B frame.

That is, the prediction unit 503 pre-sets the prediction coding method corresponding to different frame types, so as to perform the predictive coding on the first coding unit in the frames to be encoded of different frame types according to the corresponding prediction coding method, which can further improve the accuracy of the first prediction block obtained through the predictive coding.

In the present embodiment, after the first prediction block of the frame to be encoded is obtained by the prediction unit 503, the encoding unit 504 obtains the target compressed video file according to each frame to be encoded and the corresponding first prediction block.

In the present embodiment, a video encoding process can include a prediction, a transform, a quantization, an entropy coding, an inverse quantization, an inverse transform, and a loop filtering.

For the prediction process, the first coding unit is taken as the original pixel block, and an intra prediction or an inter prediction is performed on the first coding unit to obtain the first prediction block; The original pixel block and the first prediction block are subtracted to obtain a residual pixel block.

For the transform process, an input is the residual pixel block, and an output is a transform coefficient block obtained by transforming the residual pixel block through a matrix multiplication.

For the quantization process, the transform coefficient block is performed with a signal processing to reduce an amplitude of a signal, obtaining a quantized signal.

For the entropy coding process, the entropy coding is performed on the quantized signal to obtain a video encoding bitstream of the video.

For the inverse quantization process, the inverse transform process, and the loop filtering process, the quantized signal is performed with the inverse quantization and the inverse transform, which is then added with a prediction pixel block. The result undergoes the loop filtering to reconstruct a video image.

After obtaining the residual pixel block according to the first prediction unit and the first prediction block in the frame to be encoded, the encoding unit 504 can execute a subsequent process of the transform, the quantization, the entropy coding, the inverse quantization, the inverse transform, and the loop filtering, thereby obtaining a final target compressed video file.

In addition, when using the prediction coding method corresponding to the determined frame type to perform the predictive coding on the first coding unit according to the target decoding sub-data to obtain the first prediction block of the frame to be encoded, the prediction unit 503 can include the following steps of: when the frame type of the frame to be encoded is determined to be the I frame, determining a prediction block partition mode of the first coding unit according to the target decoding sub-data; determining a prediction block prediction mode of the first coding unit according to the target decoding sub-data; obtaining the first prediction block of the frame to be encoded according to the prediction block partition mode and the prediction block prediction mode.

That is, when determining the frame type of the frame to be encoded is the I frame, according to the target decoding sub-data corresponding to the frame to be encoded, the prediction unit 503 respectively determines the prediction block partition mode and the prediction block prediction mode of the first coding unit, so as to realize an acceleration of a prediction process in an encoding flow according to a decoding related information obtained during the decoding process. This can improve the speed and the efficiency of obtaining the first prediction block, which thereby correspondingly improves the video transcoding speed and the efficiency.

When determining the prediction block partition mode of the first coding unit according to the target decoding sub-data, the prediction unit 503 can adopt an implementation of: obtaining a first decoding residual mean value and a first decoding residual variance corresponding to the first coding unit, and a second decoding residual mean value and a second decoding residual variance corresponding to the frame to be encoded according to the residual coding bit in the target decoding sub-data; determining the prediction block partition mode of the first coding unit according to the first decoding residual mean value, the first decoding residual variance, the second decoding residual mean value and the second decoding residual variance.

When determining the prediction block prediction mode of the first coding unit according to the target decoding sub-data, The prediction unit 503 can adopt an implementation of: obtaining an angle mean value and an angle variance of the intra angular prediction mode corresponding to the first coding unit according to the intra angular prediction mode in the target decoding sub-data; determining the prediction block prediction mode of the first coding unit according to the angle mean value and the angle variance.

That is, the prediction unit 503 can, combined with the decoding sub-data corresponding to the first coding unit, accelerate a search process of the prediction block partition mode and the prediction block prediction mode, without a need to perform a search of a full partition mode or a full prediction mode. This can improve the speed and the efficiency when determining the prediction block partition mode and the prediction block prediction mode, which thereby improves the video transcoding speed and the transcoding efficiency.

The prediction unit 503 partitions the first prediction unit (that is, the prediction unit corresponding to the first coding unit) according to the determined prediction block partition mode, and then obtains the first prediction block according to the determined prediction block prediction mode.

When using the prediction coding method corresponding to the determined frame type to perform the predictive coding on the first coding unit according to the target decoding sub-data to obtain the first prediction block of the frame to be encoded, the prediction unit 503, can also include the following steps of: when the frame type of the frame to be encoded is determined to be the P frame or the B frame, determining the prediction block partition mode of the first coding unit according to the target decoding sub-data: determining a motion estimation algorithm of the first coding unit according to the target decoding sub-data; obtaining the first prediction block of the frame to be encoded according to the prediction block partition mode and the motion estimation algorithm.

That is, when determining the frame type of the frame to be encoded is the P frame or the B frame, according to the target decoding sub-data corresponding to the frame to be encoded, the prediction unit 503 respectively determines the prediction block partition mode and the motion estimation algorithm of the first coding unit, so as to realize an acceleration of the prediction process in the encoding flow according to the decoding related information obtained during the decoding process. This can improve the speed and the efficiency of obtaining the first prediction block, which thereby correspondingly improves the video transcoding speed and the efficiency.

When determining the prediction block partition mode of the first coding unit according to the target decoding sub-data, the prediction unit 503 can adopt an implementation of: obtaining a first motion vector variance corresponding to the first coding unit, and a second motion vector variance corresponding to the frame to be encoded according to the motion vector in the target decoding sub-data; obtaining a first decoding residual variance corresponding to the first coding unit, and a second decoding residual variance corresponding to the frame to be encoded according to the residual coding bit in the target decoding sub-data; determining the prediction block partition mode of the first coding unit according to the first motion vector variance, the second motion vector variance, the first decoding residual variance and the second decoding residual variance.

When determining the motion estimation algorithm of the first coding unit according to the target decoding sub-data, the prediction unit 503 can adopt an implementation of: obtaining the first motion vector variance corresponding to the first coding unit according to the target decoding sub-data; determining the motion estimation algorithm of the first coding unit according to the first motion vector variance.

In the present embodiment, a motion search process can be: first taking a motion estimation vector of the first prediction unit as a motion vector starting search point, then according to a maximum motion vector in the target decoding sub-data and the resolutions before and after the transcoding, setting a search range of a motion estimation, and finally performing the motion search process to obtain the motion vector of the first coding unit.

The prediction unit 503 can first partition the first prediction unit (that is, the prediction unit corresponding to the first coding unit) according to the determined prediction block partition mode, and then determine the motion vector and a reference frame of the first coding unit according to the determined motion estimation algorithm, and finally obtain the first prediction block according to the determined motion vector and the reference frame to.

In the technical solution of the present disclosure, the acquisition, storage and application of a user personal information comply with relevant laws and regulations, and do not violate public order and good morals.

According to the present embodiments of the present disclosure, the present disclosure also provides an electronic device, a readable storage medium, and a computer program product.

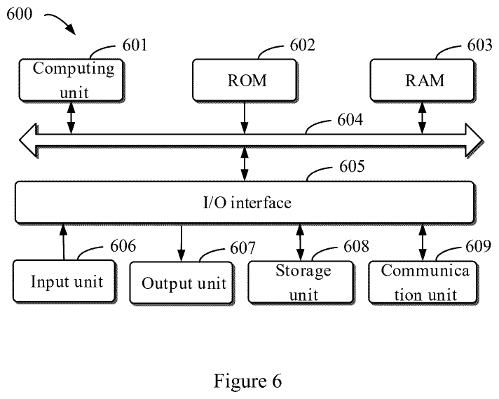

As shown in FIG. 6, a schematic is a block diagram of an electronic device for the method for video transcoding according to an embodiment of the present disclosure. The electronic device is intended to represent various forms of digital computers, such as, a laptop computer, a desktop computer, a workstation, a personal digital assistant, a server, a blade server, a mainframe computer, and other suitable computers. The electronic device can also represent various forms of mobile devices, such as, personal digital processing, cellular telephone, smart phone, wearable device and other similar computing devices. The components shown herein, the connections and relationships of the components, and the functions of the components are merely as examples, and are not intended to limit implementations of the disclosure described and/or claimed in this document.

As shown in FIG. 6, the device 600 includes a computing unit 601, which can execute various appropriate actions and processes according to a computer program stored in a Read-Only Memory (ROM) 602 or the computer program loaded from a storage unit 608 to a Random Access Memory (RAM) 603. In the RAM 603, various programs and data required for an operation of the device 600 can also be stored. The computing unit 601, the ROM 602 and the RAM 603 are connected to each other through a bus 604. An Input/Output (I/O) interface 605 is also connected to the bus 604.

Multiple components in the device 600 are connected to the I/O interface 605, including: an input unit 606, for example a keyboard, a mouse, etc. ; an output unit 607, for example various types of a display, a speaker, etc. ; the storage unit 608, for example a magnetic disk, an optical disc, etc. ; and a communication unit 609, for example a network card, a modem, a wireless communication transceiver, etc. The communication unit 609 allows the device 600 to exchange information/data with other devices through a computer network such as an Internet and/or various telecommunication networks.

The computing unit 601 can be various general-purpose and/or special-purpose processing components with a processing and a computing capability. Some examples of the computing unit 601 include but are not limited to a Central Processing Unit (CPU), a Graphics Processing Unit (GPU), various dedicated Artificial Intelligence (AI) computing chips, various computing units that run a machine learning model algorithm, a Digital Signal Processor (DSP), and any appropriate processor, controller, microcontroller, etc. The computing unit 601 executes the various methods and processes described above, for example the method for video transcoding. For example, in some embodiments, the method for video transcoding can be implemented as a computer software program, which is tangibly contained in a machine-readable medium, for example the storage unit 608.

In some embodiments, a part or all of the computer program can be loaded and/or installed onto the device 600 via the ROM 602 and/or the communication unit 609. When the computer program is loaded to the RAM 603 and executed by the computing unit 601, one or more steps of the method for video transcoding described above can be executed. Alternatively, in other embodiments, the computing unit 601 can be configured to execute the method for video transcoding by any other appropriate means (for example, by means of a firmware).

Various implementations of the systems and techniques described herein can be implemented in a digital electronic circuit system, an integrated circuit system, a Field Programmable Gate Array (FPGA), an Application-Specific Integrated Circuit (ASIC), an Application-Specific Standard Product (ASSP), a System on a Chip (SOC), a Complex Programmable Logic Device (CPLD), a computer hardware, a firmware, a software, and/or combinations thereof. The various implementations can include: an implementation in one or more computer programs, the one or more computer programs can be executable and/or interpretable on a programmable system including at least one programmable processor, the programmable processor can be a special-purpose or general-purpose programmable processor, can receive data and instructions from a storage system, at least one input device, and at least one output device, and transmit the data and the instructions to the storage system, the at least one input device, and the at least one output device.

A program code for implementing the methods of the present disclosure can be written in any combination of one or more programming languages. The program code can be provided to a processor or a controller of a general-purpose computer, a special-purpose computer, or other programmable apparatus for video transcoding, such that the program code, when executed by the processor or the controller, causes functions/operations specified in a flowchart and/or a block diagram to be implemented. The program code can be executed entirely on a machine, partly on the machine, as a stand-alone software package partly on the machine and partly on a remote machine, or entirely on the remote machine or a server.

In the context of the present disclosure, the machine-readable medium can be a tangible medium, which can contain or store a program for use by or in connection with an instruction execution system, an apparatus, or a device. The machine-readable medium can be a machine-readable signal medium or a machine-readable storage medium. The machine-readable medium can include but is not limited to an electronic, a magnetic, an optical, an electromagnetic, an infrared, or a semiconductor system, an apparatus or a device, or any suitable combination of the foregoing. More specific examples of the machine-readable storage medium would include an electrical connection based on one or more wires, a portable computer diskette, a hard disk, a Random Access Memory (RAM), a Read-Only Memory (ROM), an Erasable Programmable Read-Only Memory (EPROM or a flash memory), an optical fiber, a portable Compact Disc Read-Only Memory (CD-ROM), an optical storage device, a magnetic storage device, or any suitable combination of the foregoing.

To provide an interaction with a user, the systems and techniques described herein can be implemented on a computer having: a display device (for example, a CRT (cathode ray tube) or an LCD (liquid crystal display) monitor) for displaying an information to the user; and a keyboard and a pointing device (for example, a mouse or a trackball), through which the user can provide an input to the computer. Other kinds of devices can also be used to provide the interaction with the user; for example, a feedback provided to the user can be any form of a sensory feedback (for example, a visual feedback, an auditory feedback, or a tactile feedback); and an input from the user can be received in any form (including an acoustic input, a speech input, or a tactile input).

The systems and techniques described herein can be implemented in a computing system that includes a back-end component (for example, as a data server), or a computing system that includes a middleware component (for example, an application server), or a computing system that includes a front-end component (for example, a user computer having a graphical user interface or a web browser, through which the user can interact with an implementation of the systems and techniques described herein), or a computing system that includes any combination of such a back-end component, a middleware component, or a front-end component. The components of the system can be interconnected by any form or medium of a digital data communication (for example, a communication network). Examples of the communication network include: a Local Area Network (LAN), a Wide Area Network (WAN), and the Internet.

A computer system can include a client and a server. The client and the server are generally remote from each other and usually interact through a communication network. A relationship of the client and the server is generated by means of computer programs running on a respective computer and having a client-server relationship with each other. The server can be a cloud server, also known as a cloud computing server or a cloud host, which is a host product in a cloud computing service system, and solves defects of a large management difficulty and a weak business scalability existing in a traditional physical host and a VPS service (“Virtual Private Server”, or “VPS” for short). The server can also be a server of a distributed system, or a server combined with a blockchain.

It should be understood that various forms of a flow shown above can be used, and steps can be reordered, added, or deleted. For example, each step described in the present disclosure can be executed in parallel, or can be executed sequentially, or can be executed in a different order, as long as a desired result of the technical solution disclosed in the present disclosure can be achieved, which is not limited herein.

The above-mentioned specific embodiments do not constitute a limitation on the protection scope of the present disclosure. Those skilled in the art should understand that, according to a design requirement and other factors, various modifications, combinations, sub-combinations and substitutions can be made. Any modification, equivalent substitution, and improvement, etc., made within the spirit and principle of the present disclosure shall be included within the protection scope of the present disclosure.

What is claimed is:

1. A method for video transcoding, comprising:
decoding an initial compressed video file to obtain an original compressed video file and a decoding dataset acquired during a decoding process, wherein each decoding data in the decoding dataset respectively corresponds to a frame to be encoded in the original compressed video file;
obtaining a target decoding sub-data from decoding data corresponding to the frame to be encoded according to a position of a first coding unit in the frame to be encoded;
performing predictive coding on the first coding unit according to the target decoding sub-data to obtain a first prediction block of the frame to be encoded;
obtaining a target compressed video file according to each frame to be encoded and the corresponding first prediction block.

2. The method according to claim 1, wherein obtaining the target decoding sub-data from the decoding data corresponding to the frame to be encoded according to the position of the first coding unit in the frame to be encoded comprises:
determining a target position of the first coding unit in a frame to be decoded according to a target video resolution, an image padding pixel, an initial video resolution and the position of the first coding unit in the frame to be encoded;
obtaining a partial decoding data corresponding to the target position from the decoding data corresponding to the frame to be encoded, as the target decoding sub-data.

3. The method according to claim 1, wherein performing the predictive coding on the first coding unit according to the target decoding sub-data to obtain the first prediction block of the frame to be encoded comprises:
determining a frame type of the frame to be encoded according to the target decoding sub-data;
performing the predictive coding on the first coding unit using a prediction coding method corresponding to the frame type according to the target decoding sub-data to obtain the first prediction block of the frame to be encoded.

4. The method according to claim 3, wherein performing the predictive coding on the first coding unit using the prediction coding method corresponding to the frame type according to the target decoding sub-data to obtain the first prediction block of the frame to be encoded comprises:
when a frame type of the frame to be encoded is determined to be an I frame, determining a prediction block partition mode of the first coding unit according to the target decoding sub-data:
determining a prediction block prediction mode of the first coding unit according to the target decoding sub-data;
obtaining the first prediction block of the frame to be encoded according to the prediction block partition mode and the prediction block prediction mode.

5. The method according to claim 4, wherein determining the prediction block partition mode of the first coding unit according to the target decoding sub-data comprises:
obtaining a first decoding residual mean value and a first decoding residual variance corresponding to the first coding unit, and a second decoding residual mean value and a second decoding residual variance corresponding to the frame to be encoded according to a residual coding bit in the target decoding sub-data;
determining the prediction block partition mode of the first coding unit according to the first decoding residual mean value, the first decoding residual variance, the second decoding residual mean value and the second decoding residual variance.

6. The method according to claim 4, wherein determining the prediction block prediction mode of the first coding unit according to the target decoding sub-data comprises:
obtaining an angle mean value and an angle variance of an intra angular prediction mode corresponding to the first coding unit according to the intra angular prediction mode in the target decoding sub-data;
determining the prediction block prediction mode of the first coding unit according to the angle mean value and the angle variance.

7. The method according to claim 3, wherein performing the predictive coding on the first coding unit using the prediction coding method corresponding to the frame type according to the target decoding sub-data to obtain the first prediction block of the frame to be encoded comprises:
when a frame type of the frame to be encoded is determined to be a P frame or a B frame, determining a prediction block partition mode of the first coding unit according to the target decoding sub-data:
determining a motion estimation algorithm of the first coding unit according to the target decoding sub-data;
obtaining the first prediction block of the frame to be encoded according to the prediction block partition mode and the motion estimation algorithm.

8. The method according to claim 7, wherein determining the prediction block partition mode of the first coding unit according to the target decoding sub-data comprises:
obtaining a first motion vector variance corresponding to the first coding unit and a second motion vector variance corresponding to the frame to be encoded according to a motion vector in the target decoding sub-data;
obtaining a first decoding residual variance corresponding to the first coding unit and a second decoding residual variance corresponding to the frame to be encoded according to a residual coding bit in the target decoding sub-data;
determining the prediction block partition mode of the first coding unit according to the first motion vector variance, the second motion vector variance, the first decoding residual variance and the second decoding residual variance.

9. The method according to claim 7, wherein determining the motion estimation algorithm of the first coding unit according to the target decoding sub-data comprises:
obtaining a first motion vector variance corresponding to the first coding unit according to the target decoding sub-data;
determining the motion estimation algorithm of the first coding unit according to the first motion vector variance.

10. An electronic device, comprising:
at least one processor; and
a memory communicatively connected with the at least one processor;
wherein the memory stores instructions executable by the at least one processor, and the instructions are executed by the at least one processor to enable the at least one processor to perform a method for video transcoding, wherein the method for video transcoding comprises:
decoding an initial compressed video file to obtain an original compressed video file and a decoding dataset acquired during a decoding process, wherein each decoding data in the decoding dataset respectively corresponds to a frame to be encoded in the original compressed video file;
obtaining a target decoding sub-data from decoding data corresponding to the frame to be encoded according to a position of a first coding unit in the frame to be encoded;
performing predictive coding on the first coding unit according to the target decoding sub-data to obtain a first prediction block of the frame to be encoded;
obtaining a target compressed video file according to each frame to be encoded and the corresponding first prediction block.

11. The electronic device according to claim 10, wherein obtaining the target decoding sub-data from the decoding data corresponding to the frame to be encoded according to the position of the first coding unit in the frame to be encoded comprises:
determining a target position of the first coding unit in a frame to be decoded according to a target video resolution, an image padding pixel, an initial video resolution and the position of the first coding unit in the frame to be encoded;
obtaining a partial decoding data corresponding to the target position from the decoding data corresponding to the frame to be encoded, as the target decoding sub-data.

12. The electronic device according to claim 10, wherein performing the predictive coding on the first coding unit according to the target decoding sub-data to obtain the first prediction block of the frame to be encoded comprises:
determining a frame type of the frame to be encoded according to the target decoding sub-data;
performing the predictive coding on the first coding unit using a prediction coding method corresponding to the frame type according to the target decoding sub-data to obtain the first prediction block of the frame to be encoded.

13. The electronic device according to claim 12, wherein performing the predictive coding on the first coding unit using the prediction coding method corresponding to the frame type according to the target decoding sub-data to obtain the first prediction block of the frame to be encoded comprises:
when a frame type of the frame to be encoded is determined to be an I frame, determining a prediction block partition mode of the first coding unit according to the target decoding sub-data:
determining a prediction block prediction mode of the first coding unit according to the target decoding sub-data;
obtaining the first prediction block of the frame to be encoded according to the prediction block partition mode and the prediction block prediction mode.

14. The electronic device according to claim 13, wherein determining the prediction block partition mode of the first coding unit according to the target decoding sub-data comprises:
obtaining a first decoding residual mean value and a first decoding residual variance corresponding to the first coding unit, and a second decoding residual mean value and a second decoding residual variance corresponding to the frame to be encoded according to a residual coding bit in the target decoding sub-data;
determining the prediction block partition mode of the first coding unit according to the first decoding residual mean value, the first decoding residual variance, the second decoding residual mean value and the second decoding residual variance.

15. The electronic device according to claim 13, wherein determining the prediction block prediction mode of the first coding unit according to the target decoding sub-data comprises:
obtaining an angle mean value and an angle variance of an intra angular prediction mode corresponding to the first coding unit according to the intra angular prediction mode in the target decoding sub-data;
determining the prediction block prediction mode of the first coding unit according to the angle mean value and the angle variance.

16. The electronic device according to claim 12, wherein performing the predictive coding on the first coding unit using the prediction coding method corresponding to the frame type according to the target decoding sub-data to obtain the first prediction block of the frame to be encoded comprises:
when a frame type of the frame to be encoded is determined to be a P frame or a B frame, determining a prediction block partition mode of the first coding unit according to the target decoding sub-data:
determining a motion estimation algorithm of the first coding unit according to the target decoding sub-data;
obtaining the first prediction block of the frame to be encoded according to the prediction block partition mode and the motion estimation algorithm.

17. The electronic device according to claim 16, wherein determining the prediction block partition mode of the first coding unit according to the target decoding sub-data comprises:
obtaining a first motion vector variance corresponding to the first coding unit and a second motion vector variance corresponding to the frame to be encoded according to a motion vector in the target decoding sub-data;
obtaining a first decoding residual variance corresponding to the first coding unit and a second decoding residual variance corresponding to the frame to be encoded according to a residual coding bit in the target decoding sub-data;
determining the prediction block partition mode of the first coding unit according to the first motion vector variance, the second motion vector variance, the first decoding residual variance and the second decoding residual variance.

18. The electronic device according to claim 16, wherein determining the motion estimation algorithm of the first coding unit according to the target decoding sub-data comprises:
obtaining a first motion vector variance corresponding to the first coding unit according to the target decoding sub-data;
determining the motion estimation algorithm of the first coding unit according to the first motion vector variance.

19. A non-transitory computer readable storage medium with computer instructions stored thereon, wherein the computer instructions are used for causing a method for video transcoding, wherein the method for video transcoding comprises:
decoding an initial compressed video file to obtain an original compressed video file and a decoding dataset acquired during a decoding process, wherein each decoding data in the decoding dataset respectively corresponds to a frame to be encoded in the original compressed video file;
obtaining a target decoding sub-data from decoding data corresponding to the frame to be encoded according to a position of a first coding unit in the frame to be encoded;
performing predictive coding on the first coding unit according to the target decoding sub-data to obtain a first prediction block of the frame to be encoded;
obtaining a target compressed video file according to each frame to be encoded and the corresponding first prediction block.

20. The non-transitory computer readable storage medium according to claim 19, wherein obtaining the target decoding sub-data from the decoding data corresponding to the frame to be encoded according to the position of the first coding unit in the frame to be encoded comprises:
determining a target position of the first coding unit in a frame to be decoded according to a target video resolution, an image padding pixel, an initial video resolution and the position of the first coding unit in the frame to be encoded;
obtaining a partial decoding data corresponding to the target position from the decoding data corresponding to the frame to be encoded, as the target decoding sub-data.
